(19) United States
(12) Patent Application Publication
(10) Pub. No.: US 2019/0266610 A1
(43) Pub. Date: Aug. 29, 2019

(54) TRANSACTION MANAGEMENT USING MACHINE LEARNING AND SIMILARITY ANALYSIS

(71) Applicant: Accenture Global Solutions Limited, Dublin (IE)

(72) Inventors: Prakash GHATAGE, Bangalore (IN); Nirav SAMPAT, Mumbi (IN); Kumar VISWANATHAN, San Jose, CA (US); Harsh Kumar KATIYAR, Bangalore (IN); Billy HART, Norwalk, OH (US); Amit PORWAL, Bangalore (IN)

(21) Appl. No.: 16/263,894

(22) Filed: Jan. 31, 2019

(30) Foreign Application Priority Data
Feb. 21, 2018 (IN) 201841006604

(51) Int. Cl. G06Q 20/42; G06Q 20/40; G06N 20/00; G06K 9/00

(52) U.S. Cl. CPC G06Q 20/42; G06K 9/00483; G06N 20/00; G06Q 20/407

(57) ABSTRACT

A device may determine one or more trends by using one or more machine learning techniques to process historical transactional information included in a set of historical transactional documents. The device may receive a set of transactional documents associated with transactions between a client organization and a vendor organization. The device may generate, based on the one or more trends, a first set of exceptions indicating that one or more transactional documents are problematic transactional documents. The device may generate, using a similarity analysis technique, a second set of exceptions indicating that one or more additional transactional documents are duplicate transactional documents. The device may generate a set of claims based on one or more exceptions. The device may perform, based on the set of claims, one or more actions associated with correction or prevention of transaction processing errors relating to the set of transactional documents.

### RELATED APPLICATION

This application claims priority under 35 U.S.C. 119 to Indian Patent Application No. 201841006604, filed on Feb. 21, 2018, the content of which is incorporated by reference herein in its entirety.

### BACKGROUND

Supply chain management may include processes to manage control and visibility over products and/or services throughout a life cycle of a transaction. For example, a process may be used to monitor receipt of transactions, verification of transactions, processing of transactions, execution of transactions, reconciliation and reporting of transactions, error corrections associated with transactions, and/or the like.

### SUMMARY

According to some possible implementations, a device may include one or more memories and one or more processors that are communicatively coupled to the one or more memories. The one or more processors may obtain historical transactional information associated with a set of historical transactional documents between a client organization and a vendor organization. The one or more processors may determine one or more trends associated with values included in the set of historical transactional documents by using one or more machine learning techniques to process the historical transactional information.

The one or more processors may receive a set of transactional documents associated with transactions between the client organization and the vendor organization. The one or more processors may generate, based on the one or more trends, a first set of exceptions indicating that one or more transactional documents, of the set of transactional documents, are problematic transactional documents. The one or more processors may generate, using a similarity analysis technique, a second set of exceptions indicating that one or more additional transactional documents, of the set of transactional documents, are duplicate transactional documents. The duplicate transactional documents may have caused an account of the client organization to update erroneously or may be capable of causing the account of the client organization to update erroneously.

The one or more processors may generate a set of claims based on one or more exceptions, of the first set of exceptions, and/or one or more exceptions, of the second set of exceptions. Each claim may verify an exception, of the first set of exceptions, as a valid exception, or an exception, of the second set of exceptions, as a valid exception. The one or more processors may perform, based on the set of claims, one or more actions associated with correction or prevention of transaction processing errors relating to the set of transactional documents.

According to some possible implementations, a method may include obtaining, by a device, historical transactional information associated with a set of historical transactional documents between a client organization and a vendor organization. The method may include training, by the device, one or more data models on the historical transactional information. The one or more data models may be able to identify one or more trends associated with values included in the set of historical transactional documents.

The method may include receiving, by the device, a set of transactional documents associated with transactions between the client organization and the vendor organization. The method may include providing, by the device, one or more values included in a particular transactional document, of the set of transactional documents, as input to a data model of the one or more data models. The one or more values included in the particular transactional document, when input to the data model, cause the data model to output one or more prediction values. Each prediction value may indicate a likelihood of a particular value, of the one or more values included in the particular transactional document, being an indicator that the particular transactional document is a problematic transactional document.

The method may include generating, based on the one or more prediction values, a first set of exceptions indicating that one or more transactional documents, of the set of transactional documents, are problematic transactional documents. The method may include generating, by the device and by using a similarity analysis technique, a second set of exceptions indicating that one or more additional transactional documents, of the set of transactional documents, are duplicate transactional documents. The duplicate transactional documents may have caused an account of the client organization to update erroneously or may be capable of causing the account of the client organization to update erroneously.

The method may include generating, by the device, a set of claims based on one or more exceptions, of the first set of exceptions, and/or one or more exceptions, of the second set of exceptions. Each claim may verify an exception, of the first set of exceptions, as a valid exception, or an exception, of the second set of exceptions, as a valid exception. The method may include performing, by the device and based on the set of claims, one or more actions associated with correction or prevention of transaction processing errors relating to the set of transactional documents.

According to some possible implementations, a non-transitory computer-readable medium may store one or more instructions that, when executed by one or more processors, cause the one or more processors to obtain historical transactional information associated with a set of historical transactional documents between a client organization and a vendor organization. The one or more instructions may cause the one or more processors to determine one or more trends associated with values included in the set of historical transactional documents by using one or more machine learning techniques to process the historical transactional information.

The one or more instructions may cause the one or more processors to receive a set of transactional documents associated with transactions between the client organization and the vendor organization. The one or more instructions may cause the one or more processors to generate, based on the one or more trends, a first set of exceptions indicating that one or more transactional documents, of the set of transactional documents, are problematic transactional documents. The one or more instructions may cause the one or more processors to generate, using a similarity analysis technique, a second set of exceptions indicating that one or more additional transactional documents, of the set of transactional documents, are duplicate transactional documents. The duplicate transactional documents may have caused an account of the client organization to update erroneously or may be capable of causing the account of the client organization to update erroneously.

The one or more instructions may cause the one or more processors to provide the first set of exceptions and the second set of exceptions to a device associated with the client organization. The device associated with the client organization may generate a set of exceptions based on one or more exceptions, of the first set of exceptions, and/or one or more exceptions, of the second set of exceptions. Each claim may verify an exception, of the first set of exceptions, as a valid exception, or an exception, of the second set of exceptions, as a valid exception.

The one or more instructions may cause the one or more processors to receive the set of claims from the device associated with the client organization. The one or more instructions may cause the one or more processors to perform, based on the set of claims, one or more actions associated with correction or prevention of transaction processing errors relating to the set of transactional documents.

### BRIEF DESCRIPTION OF THE DRAWINGS

FIGS. 1A-1C are diagrams of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for generating exceptions that identify problematic transactions and/or duplicate transactions and using the exceptions to perform one or more actions associated with correction or prevention of transaction processing errors.

### DETAILED DESCRIPTION

The following detailed description of example implementations refers to the accompanying drawings. The same reference numbers in different drawings may identify the same or similar elements.

An organization may implement various processes to manage control and visibility over products and/or services throughout a life cycle of a transaction. For example, an organization may implement a process for monitoring receipt of transactions, such as receipt of a transactional document identifying details relating to the transaction (e.g., an invoice), verification of transactions, processing of transactions, execution of transactions, reconciliation and reporting of transactions, error correction associated with the transactions, and/or the like.

In some cases, processing of a transaction between a vendor organization and a client organization may be a time consuming process, which may cause the vendor organization to provide duplicate transactional documents to the client organization to ensure that the transaction is processed in a timely manner. In this case, if a process for managing transactions between the vendor organization and the client organization is unable to detect the duplicate transactional documents (e.g., due to a processing error, a typographical error, etc.), the client organization may erroneously process the same transaction twice. Additionally, in some cases, a sale of a product (e.g., a good, a service, etc.) may involve two or more transactional documents (e.g., a purchasing order and an invoice), and if the process is unable to detect a discrepancy or error included in one of the two or more transactional documents, the client organization may process one of the two or more transactional documents erroneously, which may cause further issues, such as a cancellation, a processing dispute, and/or the like.

Some implementations described herein provide a transaction management platform to generate exceptions identifying problematic transactions and/or duplicate transactions, and to use the exceptions to perform actions associated with correction or prevention of transaction processing errors. For example, the transaction management platform may obtain historical transactional information associated with a set of historical transactions between a client organization and a vendor organization. In this case, the transaction management platform may determine one or more trends associated with values included in the set of historical transactional documents.

The one or more trends may include a first group of trends that identify relationships between historical values and particular transaction processing outcomes (e.g., a historical value may cause or influence an overpayment, a cancellation, a processing dispute, a delivery issue, etc.). Additionally, or alternatively, the one or more trends may include a second group of trends that identify relationships that are not directly related to particular transaction processing outcomes, but that may be used to prevent the particular transaction processing outcomes.

Additionally, the transaction management platform may receive a set of transactional documents between the client organization and the vendor organization. In this case, the transaction management platform may process the set of transactional documents to generate a first set of exceptions indicating that one or more transactional documents, of the set of transactional documents, are problematic transactional documents. The first set of exceptions may be documents, files, error messages, and/or the like, and may include information indicating that one or more transactional documents are problematic transactional documents, information describing why the one or more transactional documents are problematic transactional documents, information indicating whether an exception is a warning or a notification, and/or the like.

Additionally, or alternatively, the transaction management platform may process the set of transactional documents to generate a second set of exceptions. For example, the transaction management platform may use a similarity analysis technique (e.g., a direct matching technique, a fuzzy matching technique, etc.) to generate a second set of exceptions. The second set of exceptions may be documents, files, error messages, and/or the like, and may include information indicating that one or more additional transactional documents are duplicate transactional documents, information describing why the one or more additional transactional documents are duplicate transactional documents, information indicating whether an exception is a warning or a notification and/or the like.

Furthermore, the transaction management platform may generate a set of claims based on the first set of exceptions and/or the second set of exceptions. A claim may be a document verifying that a particular exception is a valid exception. The claim may include information describing why the particular exception was generated, information describing why the particular exception is valid, transactional document information for the particular transactional document, related historical transactional document information, information associated with particular trends, and/or the like. Additionally, the transaction management platform may, based on the set of claims, perform one or more actions associated with correction or prevention of transaction processing errors.

By performing actions to prevent transaction processing errors, the transaction management platform conserves processing resources that might otherwise be used to resolve issues relating to duplicate transactions and/or problematic transactions. Additionally, by performing actions that are preventative or proactive in nature, the transaction management platform conserves processing resources and/or network resources relative to an inferior platform that is only able to resolve issues reactively (e.g., the inferior platform may spend processing resources and/or network resources to execute error correction procedures). Furthermore, by correcting and/or preventing transaction processing errors, the transaction management platform conserves financial resources of the client organization (e.g., by reducing or eliminating processing errors, by reducing or eliminating human resources devoted to managing the processing of transactions, etc.).

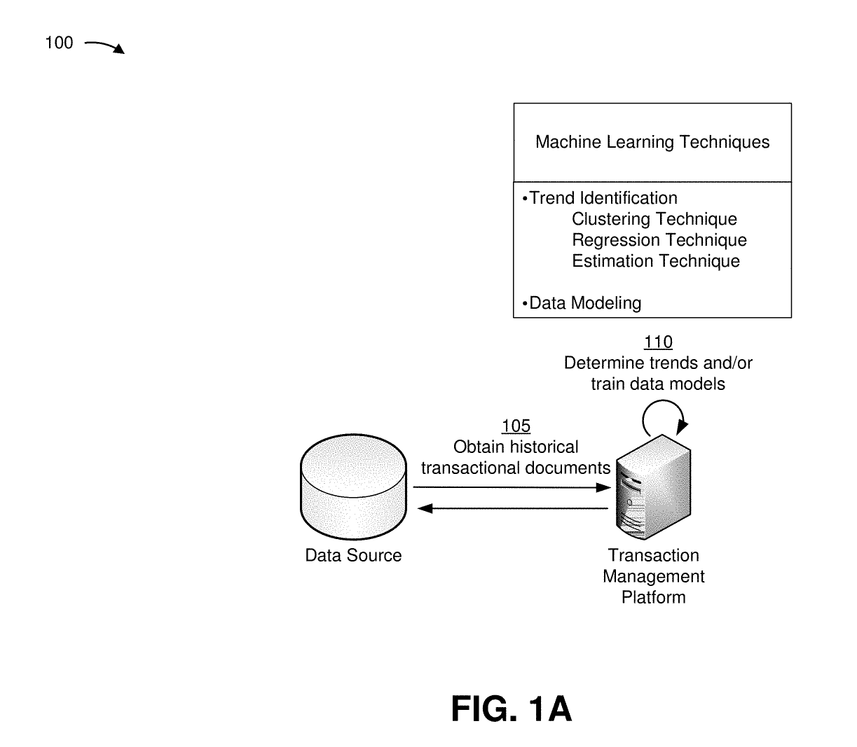

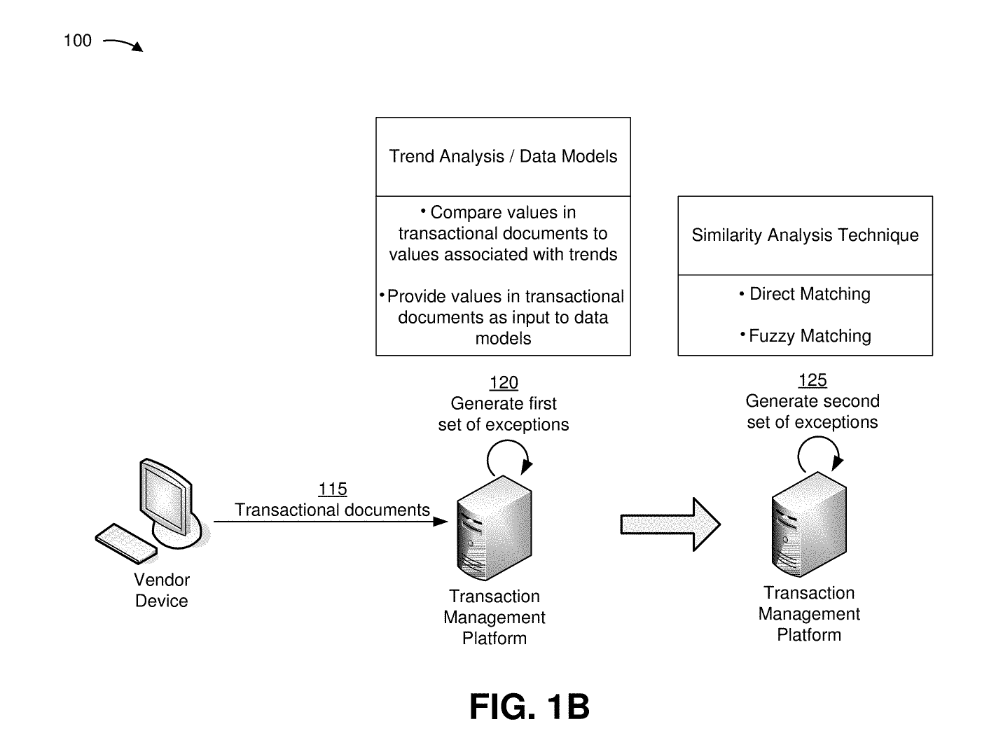

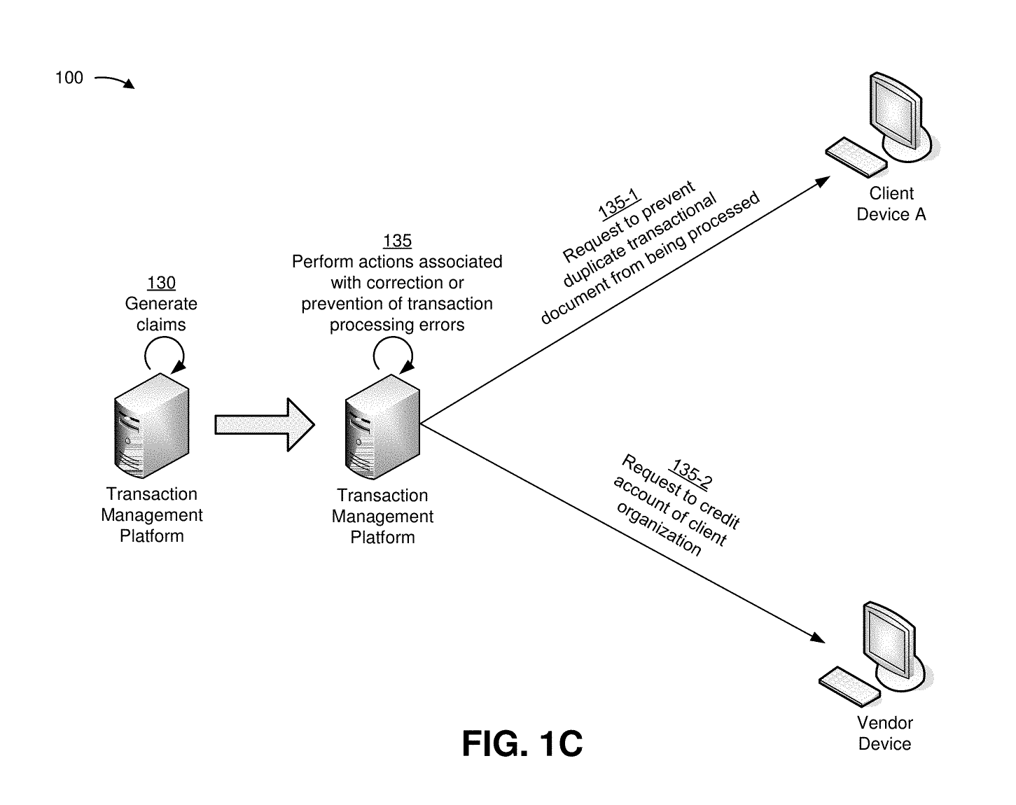

FIGS. 1A-1C are diagrams of an overview of an example implementation 100 described herein. As shown in FIGS. 1A-1C, example implementation 100 may include a transaction management platform to generate exceptions identifying problematic transactions and/or duplicate transactions, and to use the exceptions to perform actions associated with correction or prevention of transaction processing errors.

As shown in FIG. 1A, and by reference number 105, the transaction management platform may obtain a set of historical transactional documents from a data source. The historical transactional information may include transactional information for documents that have already been processed, such as invoices, purchasing orders, inventory-related documents, accounts payable documents, payroll documents, documents relating to the delivery of a product associated with a particular transaction, and/or the like.

Additionally, the historical transactional information may include values included in each transactional document (e.g., a transaction amount, a vendor name, a processing date, etc.), cancellation information indicating whether a cancellation was made, transaction dispute information indicating whether processing of a particular historical transaction was disputed, delivery information indicating whether a delivery of a product associated with a transaction was performed in a timely manner, claim information indicating whether a claim was generated for a particular historical transactional document and any information associated with the claim, and/or the like.

As shown by reference number 110, the transaction management platform may determine one or more trends associated with values included in the historical transactional information and/or may train one or more data models on the historical transactional information. For example, the transaction management platform may determine one or more trends identifying particular historical transactional documents as problematic transactional documents. A problematic transactional document, while defined in detail further herein, may be a transactional document that is likely to cause or influence a particular transaction processing outcome (e.g., an overpayment, a cancellation, etc.). Additionally, the transaction management platform may determine one or more trends by processing the historical transactional information using one or more machine learning techniques, such as a clustering technique, a regression technique, an estimation technique, and/or the like, as each described further herein.

The one or more trends may include a first group of trends that identify relationships between historical values and particular transaction processing outcomes. The first group of trends may associate values included in historical transactional documents with particular transaction processing outcomes by identifying a likelihood of particular values causing or influencing a particular transaction processing outcome, such as a trend indicating that a particular value included in a historical transactional document has a threshold chance of causing the account of the client organization to update erroneously, a threshold chance of causing or influencing a cancellation, a threshold chance of causing or influencing a processing dispute, a threshold chance of causing or influencing a delivery issue, and/or the like, as each described further herein.

Additionally, or alternatively, the one or more trends may include a second group of trends that identify relationships that are not directly related to particular transaction processing outcomes, but that may be further analyzed to prevent particular transaction processing outcomes. The second group of trends may include a trend indicating a time period at which the vendor organization is likely to provide a duplicate transactional document to the client organization, a trend indicating a particular type of error (e.g., a typographical error) that frequently occurs in a particular field of a transactional document, and/or the like.

Additionally, or alternatively, the transaction management platform may train one or more data models on the historical transactional information to identify a particular transactional document's likelihood of being a problematic transactional document. For example, the transaction management platform may train a data model by associating values included in the set of historical transactional documents with configurable values that identify each value's likelihood of being an indicator of a particular historical transactional document being a problematic transactional document. In this way, when the transaction management platform begins to receive new transactional documents (referred to herein as transactional documents), values included in the transactional documents may be scored by the model, as described further herein.

In this way, the transaction management platform is able to determine trends and/or train data models capable of identifying problematic transactional documents.

As shown in FIG. 1B, and by reference number 115, the transaction management platform may receive, from a vendor device, a set of transactional documents. For example, the transaction management platform may receive a set of transactional documents associated with transactions between a client organization and a vendor organization. The set of transactional documents may include any document associated with a transaction between the client organization and the vendor organization, such as an invoice, a purchasing order, an inventory-related document, an accounts payable document, a payroll document, a document relating to the delivery of a product associated with a particular transaction, and/or the like.

As shown by reference number 120, the transaction management platform may generate a first set of exceptions indicating that one or more transactional documents, of the set of transactional documents, are problematic transactional documents. A problematic transactional document may be a transactional document that includes incorrect values, a transactional document that has a threshold chance of causing the account of the client organization to update erroneously, a transactional document that has a threshold chance of being associated with or causing a cancellation, a transactional document that has a threshold chance of being associated with or causing a processing dispute (e.g., a payment dispute), a transactional document that has a threshold chance of being associated with or causing a delivery issue, and/or the like.

The first set of exceptions may be documents, files, error messages, and/or the like, and may include information indicating that one or more transactional documents are problematic transactional documents, information describing why the one or more transactional documents are problematic transactional documents, information indicating whether an exception is a warning or a notification, and/or the like. In some cases, the information describing why a transactional document is a problematic transactional document may be based on one or more values included in the transactional document being similar to one or more values associated with a trend in the set of historical transactional documents. In this case, if a value included in a transactional document satisfies a threshold level of similarity with a value associated with a trend, the transaction management platform may generate an exception.

In some implementations, the transaction management platform may generate an exception based on the one or more trends. For example, the transaction management platform may compare values associated with the one or more trends and one or more values included in the set of transactional documents, and may, based on the comparison, generate a second set of exceptions.

As an example, assume a trend for a reoccurring transaction includes a static value for a transaction balance, such as $5,000. Further, assume the transaction management platform receives a transactional document for the same reoccurring transaction with a new balance of $50,000. In this case, the transaction management platform may determine that the new balance is a threshold amount above the static balance, which may cause the transaction management platform to generate an exception.

Additionally, or alternatively, the transaction management platform may generate an exception based on the one or more data models. For example, the transaction management platform may provide one or more values included in a transactional document as input to a data model to cause the data model to output a prediction value indicating a likelihood of the transactional document being a problematic transactional document. If the prediction value indicating the likelihood of the transactional document being a problematic transactional document satisfies a threshold value, then the transaction management platform may generate an exception.

As shown by reference number 125, the transaction management platform may generate a second set of exceptions indicating that one or more transactional documents, of the set of transactional documents, are duplicate transactional documents. The second set of exceptions may be documents, files, error messages, and/or the like, and may include information indicating that one or more transactional documents are duplicate transactional documents, information describing why the one or more transactional documents are duplicate transactional documents (e.g., information indicating that a threshold number of values in a first transactional document match corresponding values included in a second transactional document), information indicating whether an exception is a warning or a notification (e.g., a warning that a duplicate transactional document may cause a processing error, a notification that the duplicate transactional document has already caused the processing error, etc.), and/or the like.

In some implementations, the transaction management platform may use a similarity analysis technique to generate a second set of exceptions. For example, the transaction management platform may use a similarity analysis technique (e.g., a direct matching technique, a fuzzy matching technique, etc.) to compare values included in a transactional document to values included in one or more previously received transactional documents, and may generate an exception if the values included in the transactional document satisfy a threshold level of similarity with values included in a previously received transactional document. In this case, the transaction management platform may also identify whether the transactional document has caused an account of the client organization to update erroneously (or if the transactional document is simply capable of causing the account of the client organization to update erroneously).

In this way, the transaction management platform is able to generate exceptions when a problematic transactional document is identified.

As shown in FIG. 1C, and by reference number 130, the transaction management platform may generate a set of claims. For example, the transaction management platform may generate a set of claims based on one or more of the first set of exceptions and one or more of the second set of exceptions.

A claim may be a document verifying that a particular exception is a valid exception. The claim may include information describing why the particular exception was generated, information describing why the particular exception is valid, transactional document information for the particular transactional document, related historical transactional document information, information associated with particular trends, and/or the like. In some cases, the claim may be generated so as to be used for data analytics (e.g., the claim may be used to train a data model).

As shown by reference number 135, the transaction management platform may perform one or more actions associated with correction or prevention of transaction processing errors. For example, assume a particular claim indicates that a duplicate transactional document is capable of causing the account of the client organization to update erroneously (e.g., a duplicate payment has not been made, but is capable of being made as a result of the client organization receiving the duplicate transactional document). In this case, and as shown by reference number 135-1, the transaction management platform may provide, to a client device (shown as Client Device A), a request to prevent the duplicate transactional document from being processed (e.g., a request for a stop payment).

As another example, assume a particular claim indicates that a duplicate transactional document has caused the account of the client organization to update erroneously (e.g., a duplicate payment was made prior to identification of the duplicate transactional document). In this case, and as shown by reference number 135-2, the transaction management platform may provide, to a vendor device, a request to credit the account of the client organization.

In some implementations, the transaction management platform may perform additional actions, such as one or more actions associated with reducing a likelihood of a transactional document causing or influencing a cancellation, one or more actions associated with reducing a likelihood of a transactional document causing or influencing a processing dispute, one or more actions associated with reducing a likelihood of a transactional document causing or influencing a delivery issue, and/or the like, as each described further herein. Furthermore, in some cases, the vendor organization may offer a discount if a particular transactional document is processed before a discount deadline, and the transaction management platform may generate scheduling information for the particular transactional document to ensure that the particular transactional document is processed before the discount deadline.

In this way, the transaction management platform is able to prevent and/or correct transaction processing errors. Furthermore, the transaction management platform conserves processing resources that might otherwise be used to resolve issues relating to duplicate transactions and/or problematic transactions.

As indicated above, FIGS. 1A-1C are provided merely as an example. Other examples are possible and may differ from what was described with regard to FIGS. 1A-1C. For example, there may be additional devices and/or networks, fewer devices and/or networks, different devices and/or networks, or differently arranged devices and/or networks than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) of example implementation 100 may perform one or more functions described as being performed by another set of devices of example implementation 100.

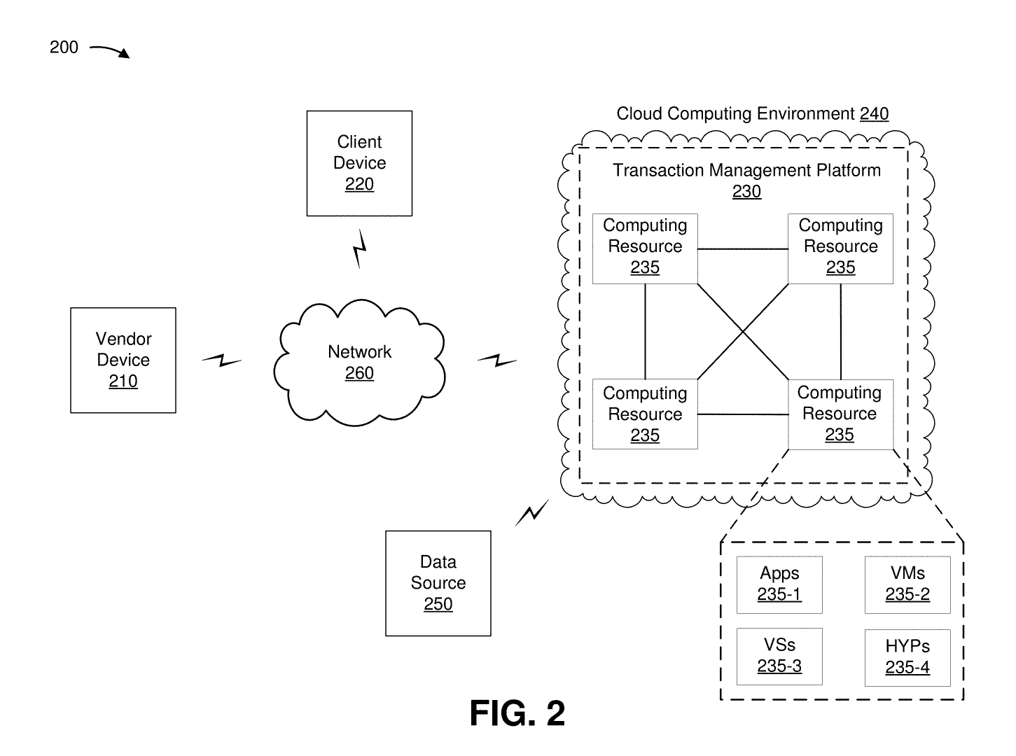

FIG. 2 is a diagram of an example environment 200 in which systems and/or methods, described herein, may be implemented. As shown in FIG. 2, example environment 200 may include a vendor device 210, a client device 220, a transaction management platform 230 hosted by a cloud computing environment 240, a data source 250, and/or a network 260. Devices of example environment 200 may interconnect via wired connections, wireless connections, or a combination of connections.

Vendor device 210 includes one or more devices capable of receiving, generating, storing, processing, and/or providing information associated with a set of transactional documents. For example, vendor device 210 may include a communication and/or computing device, such as a phone (e.g., a mobile phone, such as a smartphone, a radiotelephone, etc.), a laptop computer, a tablet computer, a handheld computer, a gaming device, a wearable communication device (e.g., a smart wristwatch, a pair of smart eyeglasses, etc.), or a similar type of device.

In some implementations, vendor device 210 may be a device accessible to an employee of the vendor organization, such as a communication and/or computing device accessible to a supply chain manager, a sales representative, a delivery manager, and/or the like. In some implementations, vendor device 210 may provide a set of transactional documents to transaction management platform 230. In some implementations, vendor device 210 may receive a request to credit an account of a client organization from transaction management platform 230 or client device 220. In some implementations, vendor device 210 may receive a request to update incorrect transactional document information from transaction management platform or client device 220.

Client device 220 includes one or more devices capable of receiving, generating, storing, processing, and/or providing information associated with a set of exceptions. For example, client device 220 may include a communication and/or computing device, such as a phone (e.g., a mobile phone, such as a smartphone, a radiotelephone, etc.), a laptop computer, a tablet computer, a handheld computer, a gaming device, a wearable communication device (e.g., a smart wristwatch, a pair of smart eyeglasses, etc.), or a similar type of device.

In some implementations, client device 220 may be a device accessible to an employee of the client organization, such as a communication and/or computing device accessible to a supply chain manager, a sales representative, a delivery manager, and/or the like. In some implementations, client device 220 may receive a set of exceptions from transaction management platform 230. In some implementations, client device 220 may generate the set of exceptions, and may provide the set of exceptions to transaction management platform 230.

Transaction management platform 230 includes one or more devices capable of receiving, storing, generating, processing, and/or providing information associated with a set of transactional documents. For example, transaction management platform 230 may include a server device (e.g., a host server, a web server, an application server, etc.), a data center device, or a similar device.

In some implementations, transaction management platform 230 may interact with one or more devices described herein using an application programming interface (API). For example, transaction management platform 230 may provide, to vendor device 210 and/or client device 220, a recommended action associated with reducing a likelihood of a transactional document causing or influencing a cancellation, a processing dispute, a delivery issue, and/or the like.

In some implementations, as shown, transaction management platform 230 may be hosted in cloud computing environment 240. Notably, while implementations described herein describe transaction management platform 230 as being hosted in cloud computing environment 240, in some implementations, transaction management platform 230 might not be cloud-based (i.e., may be implemented outside of a cloud computing environment) or might be partially cloud-based.

Cloud computing environment 240 includes an environment that hosts transaction management platform 230. Cloud computing environment 240 may provide computation, software, data access, storage, and/or other services that do not require end-user knowledge of a physical location and configuration of system(s) and/or device(s) that host transaction management platform 230. As shown, cloud computing environment 240 may include a group of computing resource 235 (referred to collectively as “computing resources 235 and individually as “computing resource 235”).

Computing resource 235 includes one or more personal computers, workstation computers, server devices, or another type of computation and/or communication device. In some implementations, computing resource 235 may host transaction management platform 230. The cloud resources may include compute instances executing in computing resource 235, storage devices provided in computing resource 235, data transfer devices provided by computing resource 235, etc. In some implementations, computing resource 235 may communicate with other computing resources 235 via wired connections, wireless connections, or a combination of wired and wireless connections.

As further shown in FIG. 2, computing resource 235 may include a group of cloud resources, such as one or more applications (“APPs”) 235-1, one or more virtual machines (“VMs”) 235-2, virtualized storage (“VSs”) 235-3, one or more hypervisors (“HYPs”) 235-4, or the like.

Application 235-1 includes one or more software applications that may be provided to or accessed by vendor device 210 and/or client device 220. Application 235-1 may eliminate a need to install and execute the software applications on vendor device 210 and/or client device 220. For example, application 235-1 may include software associated with transaction management platform 230 and/or any other software capable of being provided via cloud computing environment 240. In some implementations, one application 235-1 may send/receive information to/from one or more other applications 235-1, via virtual machine 235-2.

Virtual machine 235-2 includes a software implementation of a machine (e.g., a computer) that executes programs like a physical machine. Virtual machine 235-2 may be either a system virtual machine or a process virtual machine, depending upon use and degree of correspondence to any real machine by virtual machine 235-2. A system virtual machine may provide a complete system platform that supports execution of a complete operating system (“OS”). A process virtual machine may execute a single program, and may support a single process. In some implementations, virtual machine 235-2 may execute on behalf of a user (e.g., vendor device 210 and/or client device 220), and may manage infrastructure of cloud computing environment 240, such as data management, synchronization, or long-duration data transfers.

Virtualized storage 235-3 includes one or more storage systems and/or one or more devices that use virtualization techniques within the storage systems or devices of computing resource 235. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 235-4 provides hardware virtualization techniques that allow multiple operating systems (e.g., “guest operating systems”) to execute concurrently on a host computer, such as computing resource 235. Hypervisor 235-4 may present a virtual operating platform to the guest operating systems, and may manage the execution of the guest operating systems. Multiple instances of a variety of operating systems may share virtualized hardware resources.

Data source 250 includes one or more devices capable of receiving, storing, processing, and/or providing information associated with historical transactional documents. For example, data source 250 may include a server device, a group of server devices, a camera, a sensor, and/or the like. In some implementations, data source 250 may store historical transactional documents that may be provided to transaction management platform 230 (e.g., to allow transaction management platform 230 to use the historical transactional documents to determine trends and/or to train data models).

In some implementations, data source 250 may be a sensor that is located near a physical location where an employee of a vendor organization or a client organization is to input values into a particular transactional document (e.g., a physical paper copy of a transactional document). In this case, data source 250 may monitor the particular transactional document as the particular transactional document is being filled out by a user (e.g., a user may input values into fields of the particular transactional document). Additionally, data source 250 may capture the values being input into the particular transactional document (e.g., by taking a screenshot of the particular transactional document, by recording a user who says the input values out loud, etc.). Furthermore, data source 250 may provide the information being input into the particular transactional document to transaction management platform 230 for further processing.

Network 260 includes one or more wired and/or wireless networks. For example, network 260 may include a cellular network (e.g., a fifth generation (5G) network, a fourth generation (4G) network, such as a long-term evolution (LTE) network, a third generation (3G) network, a code division multiple access (CDMA) network, another type of advanced generated network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of example environment 200 may perform one or more functions described as being performed by another set of devices of example environment 200.

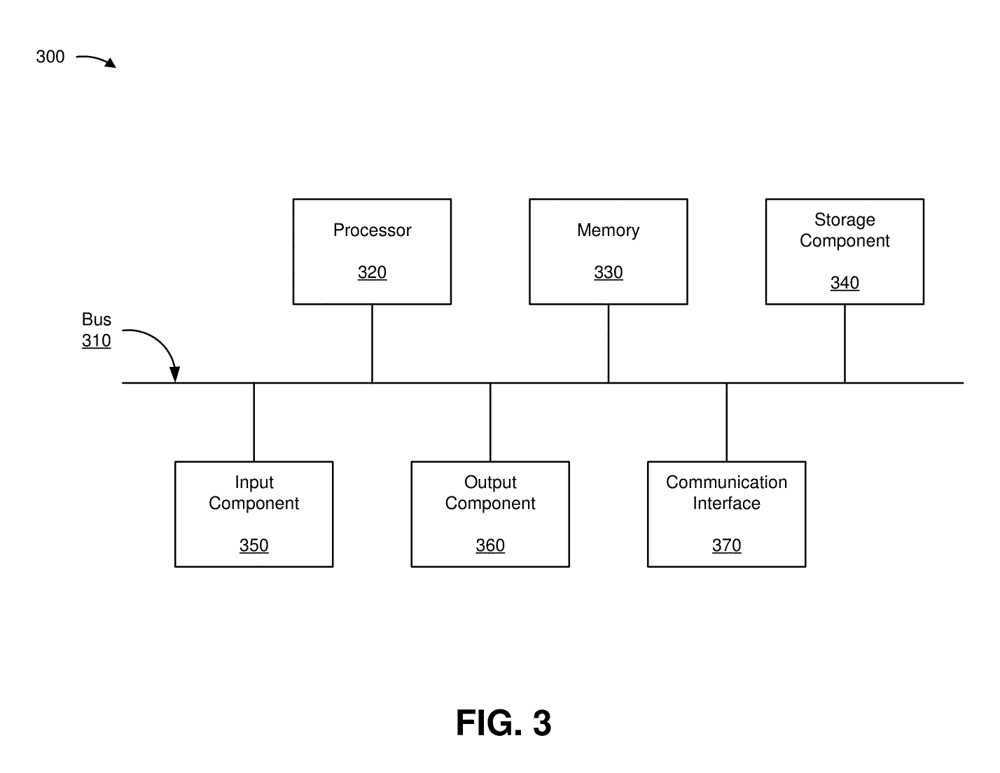

FIG. 3 is a diagram of example components of a device 300. Device 300 may correspond to vendor device 210, client device 220, transaction management platform 230, and/or data source 250. In some implementations, vendor device 210, client device 220, transaction management platform 230, and/or data source 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in location of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

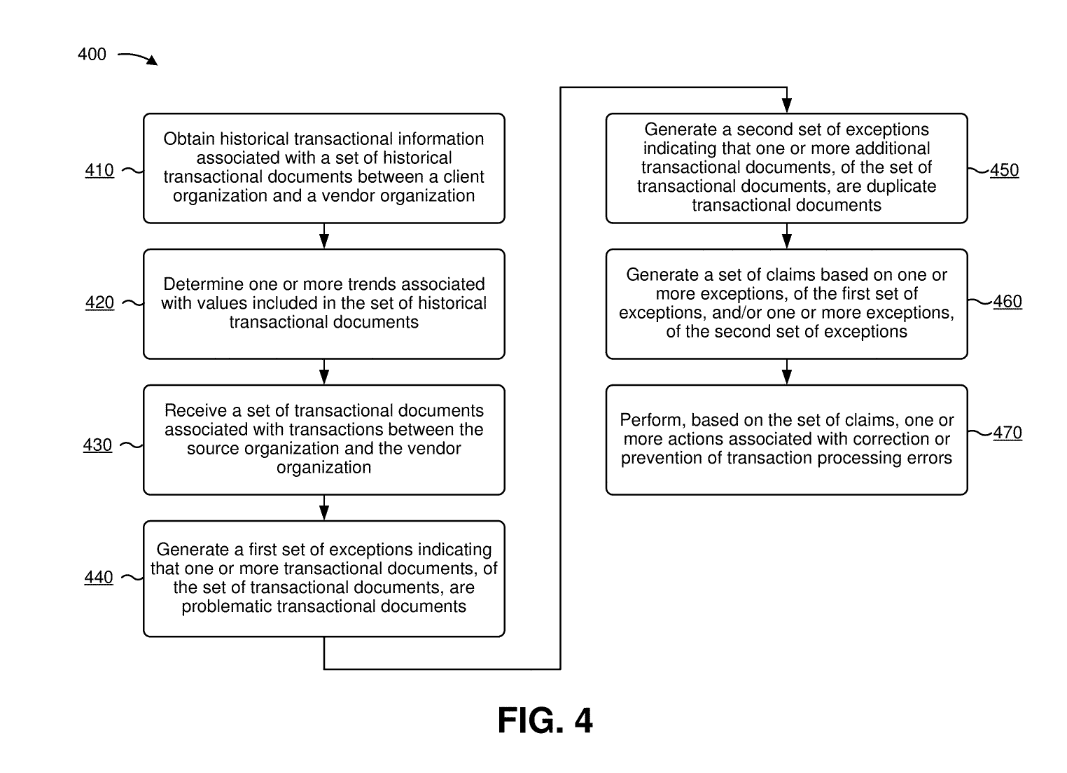

FIG. 4 is a flow chart of an example process 400 for generating exceptions that identify duplicate transactions and/or problematic transactions and using the exceptions to perform one or more actions associated with correction or prevention of transaction processing errors. In some implementations, one or more process blocks of FIG. 4 may be performed by transaction management platform 230. In some implementations, one or more process blocks of FIG. 4 may be performed by another device or a group of devices separate from or including transaction management platform 230, such as vendor device 210, client device 220, and/or data source 250.

As further shown in FIG. 4, process 400 may include obtaining historical transactional information associated with a set of historical transactional documents between a client organization and a vendor organization (block 410). For example, transaction management platform 230 (e.g., computing resource 235, processor 320, memory 330, storage component 340, etc.) may obtain, from data source 250, historical transactional information associated with a set of historical transactional documents.

In some implementations, data source 250 may store historical transactional information. For example, data source 250 may store the historical transactional information using a data structure, such as a linked-list, an array, a tree, a graph, a database, and/or the like. The set of historical transactional documents may include any document associated with a transaction between the client organization and the vendor organization, such as an invoice, a purchasing order, an inventory-related document, an accounts payable document, a payroll document, a document relating to the delivery of a product associated with a particular transaction, and/or the like.

In some implementations, transaction management platform 230 may obtain historical transactional information from data source 250. For example, transaction management platform 230 may search (e.g., query) data source 250 to obtain historical transactional information (e.g., in bulk, periodically over an interval, etc.). In some implementations, data source 250 may be configured to automatically provide the historical transactional information to transaction management platform 230 (e.g., in bulk, periodically over the interval, etc.).

In this way, transaction management platform 230 is able to obtain historical transactional information associated with a set of historical transactional documents between a client organization and a vendor organization.

As further shown in FIG. 4, process 400 may include determining one or more trends associated with values included in the set of historical transactional documents (block 420). For example, transaction management platform 230 (e.g., computing resource 235, processor 320, memory 330, storage component 340, etc.) may process the historical transactional information to determine one or more trends identifying particular historical transactional documents as problematic transactional documents. In this way, the one or more trends may be used to flag transactional documents (e.g., new incoming transactional documents) as problematic transactional documents, as described further herein. Additionally, or alternatively, transaction management platform 230 may train one or more data models to identify a particular transactional document's likelihood of being a problematic transactional document.

The one or more trends may include a first group of trends that identify relationships between historical values and particular transaction processing outcomes. The first group of trends may associate values included in historical transactional documents with particular transaction processing outcomes by identifying a likelihood of particular values causing or influencing a particular transaction processing outcome, such as a trend indicating that a particular value included in a historical transactional document has a threshold chance of causing the account of the client organization to update erroneously, a threshold chance of causing or influencing a cancellation, a threshold chance of causing or influencing a processing dispute, a threshold chance of causing or influencing a delivery issue, and/or the like, as each described further herein.

Additionally, or alternatively, the one or more trends may include a second group of trends that identify relationships that are not directly related to particular transaction processing outcomes, but that may be further analyzed to prevent particular transaction processing outcomes. The second group of trends may include a trend indicating a time period at which the vendor organization is likely to provide a duplicate transactional document to the client organization, a trend indicating a particular type of error (e.g., a typographical error) that frequently occurs in a particular field of a transactional document, and/or the like.

In some implementations, transaction management platform 230 may determine one or more trends associated with the values included in the set of historical transactional documents. For example, transaction management platform 230 may determine one or more trends by processing the historical transactional information using one or more machine learning techniques, such as a clustering technique (e.g., a K-means clustering technique), a regression technique (e.g., a logistic regression technique), an estimation technique (e.g., a Bayesian estimation technique), and/or the like.

As an example, transaction management platform 230 may use an estimation technique to determine a trend indicating that one or more values included in the set of historical transactional documents having a threshold chance of causing or influencing the account of the client organization to update erroneously. In this example, transaction management platform 230 may determine, for a particular field included in multiple historical transactional documents, processing statistics associated with the particular field (e.g., an average value, a minimum value, a maximum value, a value that is an outlier from the average value, etc.).

Additionally, transaction management platform 230 may compare the processing statistics to claim information indicating which historical transactional documents, of the set of historical transactional documents, were associated with the account of the client organization updating erroneously, to determine a trend indicating that particular values are likely to have caused or influenced the account of the client organization to update erroneously. As a specific example, there may be a reoccurring typographical error in an invoice that causes an incorrect value to be charged to the client organization.

As another example, transaction management platform 230 may use a regression technique to determine a trend associated with a cancellation of a particular type of historical transactional document. For example, transaction management platform 230 may identify a trend indicating that a first historical transactional document (e.g., an invoice) has a threshold chance of causing a cancellation of an order if there is a discrepancy in a particular value between the first historical transactional document and a second historical transactional document (e.g., a purchasing order), a trend indicating that historical transactional documents that postpone processing are a threshold degree more likely to be cause or be associated with a cancellation (relative to transactional documents that do not postpone processing), a trend indicating that the higher (or lower) the transaction amount value, the more likely or less likely a historical transactional document is to be associated with a cancellation, a trend indicating that a particular type of historical transactional document is more likely to be associated with a cancellation than similar types of historical transactional documents, and/or the like.

As another example, transaction management platform 230 may use a regression technique or estimation technique to determine a trend associated with a processing dispute for a particular historical transactional document. For example, transaction management platform 230 may identify a trend indicating that an error or a discrepancy in a particular type of historical transactional document is likely to cause a processing dispute, a trend indicating that an error or discrepancy associated with a field or type of value included in a historical transactional document is likely to cause a processing dispute, a trend indicating that a discrepancy between a first historical transactional document (e.g., a purchasing order) and a second historical transactional document (e.g., an invoice) is likely to cause a processing dispute, and/or the like.

As another example, transaction management platform 230 may use a regression technique or estimation technique to determine a trend associated with a delivery issue for a product or service relating to the particular historical transactional document. For example, transaction management platform 230 may identify a trend indicating that an error or a discrepancy in a particular type of historical transactional document or a particular value included in a historical transactional document is likely to cause a delivery issue (e.g., a missing or incorrect value may delay processing which may cause a vendor organization to hold delivery of a product), a trend indicating that an error or discrepancy between a first transactional document and a second transactional document is likely to cause a delivery issue, and/or the like.

As another example, transaction management platform 230 may use a regression technique, such as a logistic regression technique, to determine a trend indicating a time period at which the vendor organization is likely to provide a duplicate transactional document. In this example, transaction management platform 230 may use the regression technique to process date values identifying a time period at which each historical transactional document was provided to the client organization.

Additionally, transaction management platform 230 may use the regression technique to determine, for each historical transactional document or for each type of historical transactional document, a rule that may be used to determine the time period at which the vendor organization is likely to provide the duplicate transactional document. As an example, a vendor organization may provide an invoice to the client organization, where the invoice has to be paid within thirty days. The vendor organization may also provide a duplicate invoice (e.g., as a reminder) to the client organization exactly fifteen days after sending the original invoice.

Additionally, or alternatively, transaction management platform 230 may train a data model based on the historical transactional information. For example, transaction management platform 230 may train a data model by associating values included in the set of historical transactional documents with configurable values that identify each value's likelihood of being an indicator of a particular historical transactional document being a problematic transactional document. In this way, when transaction management platform 230 begins to receive new transactional documents, values included in the new transactional documents may be scored by the model, as described further herein.

As an example, if a particular recurring typographical error often led to a processing dispute between the client organization and the vendor organization, transaction management platform 230 may train a data model that associates the particular recurring typographical error with a configurable value indicating that a particular historical transactional document is likely to be a problematic transactional document.

As another example, if a trend indicates that a particular value included in a historical transactional document caused or influenced a particular transaction processing outcomes, then transaction management platform 230 may train a data model to associate the particular value with a configurable value indicating that the historical transactional document is likely to be a problematic transactional document.

In this way, transaction management platform 230 is able to determine one or more trends associated with values included in the set of historical transactional documents and/or is able to train data models that identify a particular transactional document's likelihood of being a problematic transactional document.

As further shown in FIG. 4, process 400 may include receiving a set of transactional documents associated with transactions between the client organization and the vendor organization (block 430). For example, transaction management platform 230 (e.g., computing resource 235, processor 320, memory 330, storage component 340, etc.) may receive, from vendor device 210, a set of transactional documents associated with transactions between the client organization and the vendor organization. The set of transactional documents may include any document associated with a transaction between the client organization and the vendor organization, such as an invoice, a purchasing order, an inventory-related document, an accounts payable document, a payroll document, and/or the like.

In some implementations, transaction management platform 230 may receive a set of transactional documents from vendor device 210. For example, transaction management platform 230 may receive a set of transactional documents periodically (e.g., once a day, once an hour, once per threshold time period, etc.). Additionally, transaction management platform 230 may receive the set of transactional documents via a secure medium (e.g., using a secure file transfer protocol (SFTP)).

In this way, transaction management platform 230 is able to receive a set of transactional documents associated with transactions between the client organization and the vendor organization.

As further shown in FIG. 4, process 400 may include generating a first set of exceptions indicating that one or more transactional documents, of the set of transactional documents, are problematic transactional documents (block 440). For example, transaction management platform 230 (e.g., computing resource 235, processor 320, memory 330, storage component 340, communication interface 370, etc.) may generate a first set of exceptions based on the one or more trends and/or the one or more data models.

The first set of exceptions may be documents, files, error messages, and/or the like, and may include information indicating that one or more transactional documents are problematic transactional documents, information describing why the one or more transactional documents are problematic transactional documents, information indicating whether an exception is a warning or a notification, and/or the like. In some cases, the information describing why a transactional document is a problematic transactional document may be based on one or more values included in the transactional document being similar to one or more values associated with a trend in the set of historical documents. In this case, if a value included in a transactional document satisfies a threshold level of similarity with a value associated with a trend, transaction management platform 230 may generate an exception.

As an example, the first set of exceptions may include a first exception to flag a transactional document as having a threshold chance of causing the account of the client organization to update erroneously, a second exception to flag the transactional document as having a threshold chance of including incorrect values, a third exception to flag the transactional document as having a threshold chance of causing or influencing a cancellation, a fourth exception to flag the transactional document as having a threshold chance of causing or influencing a processing dispute, a fifth exception to flag the transactional document as having a threshold chance of causing or influencing a delivery issue, and/or the like.

A problematic transactional document may be a transactional document that includes incorrect values, a transactional document that has a threshold chance of causing the account of the client organization to update erroneously, a transactional document that has a threshold chance of being associated with or causing a cancellation, a transactional document that has a threshold chance of being associated with or causing a processing dispute, a transactional document that has a threshold chance of being associated with or causing a delivery issue, and/or the like.

In some implementations, transaction management platform 230 may generate an exception by using the one or more trends to process the transactional information included in the set of transactional documents. For example, transaction management platform 230 may compare one or more values included in a particular transactional document, of the set of transactional documents, and one or more values associated with a trend. In this case, transaction management platform 230 may determine that a value, of the one or more values included in the particular transactional document, satisfies a threshold level of similarity with the one or more values associated with the trend. In this way, transaction management platform 230 is able to use the trend to generate an exception indicating that the transactional document is a problematic transactional document.

As an example, assume the client organization and the vendor organization engage in a reoccurring sale of a product, wherein thousands of sales are made annually. Further assume that in some cases, a first historical transactional document (e.g., a purchasing order) occasionally includes a payment amount due field that is different than a second historical transactional document (e.g., an invoice). Additionally, transaction management platform 230 may determine a trend indicating that the discrepancy in the payment amount due field caused a payment dispute between the client organization and the vendor organization. Furthermore, transaction management platform 230 may process a first transactional document (e.g., a new incoming purchasing order for the same product) and a second transactional document (e.g., a new incoming invoice for the same product) to determine whether the payment amount field in the first transactional document matched the payment amount field in the second transactional document, and may generate an exception if the payment amount field does not match.

Additionally, or alternatively, transaction management platform 230 may use one or more data models to generate an exception. For example, transaction management platform 230 may provide one or more values included in a transactional document, of the set of transactional documents, as input to a data model to cause the data model to output a prediction value indicating a likelihood of the transactional document being a problematic transactional document. If the prediction value indicating the likelihood of the transactional document being a problematic transactional document satisfies a threshold value, then transaction management platform 230 may generate an exception.

In some cases, transaction management platform 230 may generate the first set of exceptions by processing a quantity of data that may not be processed objectively by a human actor. For example, transaction management platform 230 may process tens of thousands, hundreds of thousands, or even millions of transactional documents in real-time, which may include millions, billions, or more, of different types of values included in the transactional documents. In this way, transaction management platform 230 is able to generate the first set of exceptions by processing a quantity of data that is unable to be processed objectively by a human actor.

In this way, transaction management platform 230 is able to generate a first set of exceptions indicating that one or more transactional documents are problematic transactional documents.

As further shown in FIG. 4, process 400 may include generating a second set of exceptions indicating that one or more additional transactional documents, of the set of transactional documents, are duplicate transactional documents (block 450). For example, transaction management platform 230 (e.g., computing resource 235, processor 320, memory 330, storage component 340, etc.) may generate a second set of exceptions indicating that one or more additional transactional documents are duplicate transactional documents by using a similarity analysis technique (e.g., a direct matching technique, a fuzzy matching technique, etc.) to analyze the set of transactional documents.

The second set of exceptions may be documents, files, error messages, and/or the like, and may include information indicating that one or more transactional documents are duplicate transactional documents, information describing why the one or more transactional documents are duplicate transactional documents (e.g., information indicating that a threshold number of values in a first transactional document match corresponding values included in a second transactional document), information indicating whether an exception is a warning or a notification (e.g., a warning that a duplicate transactional document may cause a processing error, a notification that the duplicate transactional document has already caused the processing error, etc.), and/or the like.

In some implementations, transaction management platform 230 may use a direct matching technique to generate an exception. For example, transaction management platform 230 may compare a first additional transactional document, of the set of transactional documents, to a second additional transactional document, of the set of transactional documents, and may generate an exception if one or more values included in a first additional transactional document match corresponding values that are included in the second additional transactional document.

As an example, assume transaction management platform 230 stores matching criteria for an invoice document that includes an invoice number field, an invoice date field, an invoice amount field, and a vendor number field. In this case, transaction management platform 230 may compare an invoice number field, an invoice date field, an invoice amount field, and a vendor number field included in a first invoice with the same fields included in a second invoice. If the matching criteria is satisfied (i.e., if the fields match), transaction management platform 230 may generate an exception to indicate that the second invoice is a duplicate transactional document.

Additionally, or alternatively, transaction management platform 230 may use a fuzzy matching technique to generate an exception. For example, transaction management platform 230 may use a fuzzy matching technique to compare particular fields included in a first additional transactional document with particular fields included in a second additional transactional document. In this case, transaction management platform 230 may generate an exception if a threshold number of characters in one or more fields of the first additional transactional document match one or more characters in a corresponding one or more fields of the second additional transactional document. In this way, transaction management platform 230 is able to identify duplicate transactions in situations where the documents are not a direct match (e.g., due to a typographical error, a discrepancy in a value of a particular field, etc.).

In some cases, transaction management platform 230 may generate the second set of exceptions by processing a quantity of data that may not be processed objectively by a human actor. For example, transaction management platform 230 may process tens of thousands, hundreds of thousands, even millions of additional transactional documents in real-time, which may include millions, billions, or more, of different types of values included in the additional transactional documents. In this way, transaction management platform 230 is able to generate the second set of exceptions by processing a quantity of data that is unable to be processed objectively by a human actor.

In this way, transaction management platform 230 is able to generate a second set of exceptions indicating that one or more transactional documents are duplicate transactional documents.

As further shown in FIG. 4, process 400 may include generating a set of claims based on one or more exceptions, of the first set of exceptions, and/or one or more exceptions, of the second set of exceptions (block 460). For example, transaction management platform 230 may (e.g., computing resource 235, processor 320, memory 330, storage component 340, communication interface 370, etc.) execute a verification procedure to verify each claim, of the first set of claims and/or of the second set of claims, and may generate a set of claims that include each exception that has been verified.

A claim may be a document verifying that a particular exception is a valid exception. The claim may include information describing why the particular exception was generated, information describing why the particular exception is valid, transactional document information for the particular transactional document, related historical transactional document information, information associated with particular trends, and/or the like. In some cases, the claim may be generated so as to be used for data analytics (e.g., the claim may be used to train a data model).

As an example, a claim may include information indicating that a particular exception, of the first set of exceptions, was generated because one or more values in a second transactional document matched one or more corresponding values in a first transactional document. The claim may also include information describing why the particular exception is valid. For example, a user may manually compare the first transactional document and the second transactional document to confirm that the second transactional document is in fact a duplicate of the first transactional document. Additionally, the claim may include related historical transactional document information and/or information associated with particular trends that were used to generate the particular exception.

In some implementations, transaction management platform 230 may automatically generate the set of claims. For example, transaction management platform 230 may execute a verification procedure on each exception, of the first set of exceptions and/or the second set of exceptions, to verify which exceptions are accurate. In this case, the verification procedure may include comparing the values associated with an exception to a verification threshold that is based on historical exceptions that have previously been confirmed to be accurate.

Additionally, or alternatively, client device 220 may generate the set of claims. For example, transaction management platform 230 may provide, to client device 220, the first set of exceptions and/or the second set of exceptions. In this case, a user may interact with an interface of client device 220 to view the first set of exceptions and/or the second set of exceptions, and may manually verify which exceptions are accurate (and are to be used to generate claims). Furthermore, client device 220 may provide the set of exceptions to transaction management platform 230 to allow transaction management platform 230 to perform one or more actions associated with correction or prevention of transaction processing errors, as described below.

In this way, transaction management platform 230 is able to generate a set of claims.

As further shown in FIG. 4, process 400 may include performing, based on the set of claims, one or more actions associated with correction or prevention of transaction processing errors (block 470). For example, transaction management platform 230 (e.g., computing resource 235, processor 320, memory 330, storage component 340, communication interface 370, etc.) may, based on the set of claims, perform one or more actions associated with preventing a duplicate transactional document from being processed, perform one or more actions associated with requesting a credit to the account of the client organization, perform one or more actions associated with reducing a likelihood of a transactional document causing or influencing a cancellation, perform one or more actions associated with reducing a likelihood of a transactional document causing or influencing a processing dispute, perform one or more actions associated with reducing a likelihood of a transactional document causing or influencing a delivery issue, and/or the like, as each described further herein.

A transaction processing error may include processing of a duplicate transactional document (e.g., which may cause the client organization to pay twice for the same product or service), a processing error that causes or influences a cancellation, a processing error that causes or influences a processing dispute, a processing error that causes of influences a delivery issue (e.g., relating to a product or service associated with a particular transactional document), and/or the like.

In some implementations, transaction management platform 230 may perform one or more actions associated with preventing a duplicate transactional document from being processed. For example, assume transaction management platform 230 generates a claim for an exception indicating that a particular transactional document is a duplicate transactional document that is capable of causing the account of the client organization to update erroneously. In this case, transaction management platform 230 may generate a request to prevent the particular transactional document from being processed. Additionally, transaction management platform 230 may provide the request to client device 220 to allow the client device 220 to stop the particular transactional document from being processed. In some cases, transaction management platform 230 may automatically stop the particular transactional document from being processed.

Additionally, or alternatively, transaction management platform 230 may perform one or more actions associated with requesting a credit to the account of the client organization. For example, assume transaction management platform 230 generates a claim for an exception indicating that a particular transactional document is a duplicate transactional document that has caused the account of the client organization to update erroneously. In this case, transaction management platform 230 may generate a request to credit the account of the client organization (e.g., a request for a refund). Additionally, transaction management platform 230 may provide the request to vendor device 210 to allow vendor device 210 to credit the account of the client organization (e.g., by providing the refund).

Additionally, or alternatively, transaction management platform 230 may perform one or more actions associated with reducing a likelihood of a transactional document causing or influencing a cancellation, a processing dispute, and/or a delivery issue. For example, assume transaction management platform 230 generates a claim for an exception that flags a transactional document as having a threshold chance of being associated with or causing a cancellation, a processing dispute, and/or a delivery issue. Further assume the transactional document is an invoice, and includes discrepancies in values (e.g., as compared to a corresponding purchasing order, as compared to previous invoices relating to the same reoccurring transaction or similar transactions, etc.).

In this case, transaction management platform 230 may generate a recommendation that includes resolution information. The resolution information may include actions that may reduce a likelihood of a transactional document causing or influencing a cancellation, a processing dispute, a delivery dispute, and/or the like. For example, the resolution information may include vendor contact information (e.g., which device or party to contact to begin to resolve a particular issue), instructions on how to resolve the issue (e.g., update the transactional document to correct an error, contact the vendor organization to request that the vendor organization correct the error, etc.), and/or the like. Additionally, transaction management platform 230 may provide the recommendation to vendor device 210 and/or client device 220.

Additionally, or alternatively, transaction management platform 230 may automatically perform one or more actions to reduce the likelihood of the transactional document causing or influencing the cancellation, the processing dispute, and/or the delivery issue. For example, transaction management platform 230 may compare one or more values identified in a flagged transactional document to one or more corresponding values included in the set of historical transactional documents. The one or more corresponding values may be associated with a trend and may be used as replacement values. In this case, transaction management platform 230 may generate an updated transactional document that includes the one or more corresponding values. Additionally, transaction management platform 230 may provide the updated transactional document to client device 220.

As another example, transaction management platform 230 may compare one or more discrepancies identified in the transactional document to a master transactional document. The master transactional document may include verified values that are to be included in a flagged transactional document. In this case, transaction management platform 230 may generate an updated transactional document based on values included in the master transactional document. Additionally, transaction management platform 230 may provide the updated transactional document to vendor device 210 and/or client device 220.

Additionally, or alternatively, transaction management platform 230 may generate summary statistics associated with the set of claims. For example, transaction management platform 230 may process the set of claims to generate summary statistics, such as a total number of transactional documents processed over a time period, a total number of exceptions identified over the time period, a total number of claims received over the time period, a frequency at which a particular type of exception is generated over the time period, a number of unidentified exceptions that caused or influenced a transaction processing error over the time period, and/or the like. Additionally, transaction management platform 230 may provide the summary statistics for display on a user interface of vendor device 210 and/or client device 220.

Additionally, or alternatively, transaction management platform 230 may generate scheduling information. For example, transaction management platform 230 may generate scheduling information for a transactional document that identifies a processing time period by which the client organization may be eligible for a discount. In this case, transaction management platform 230 may use a machine learning technique to process historical transactional information identifying a processing deadline, a discount deadline, a discount amount, a reminder time period (e.g., a day on which a vendor organization may send a duplicate transactional document as a reminder that the client organization has yet to process the transaction), and/or the like.

Additionally, transaction management platform 230 may use the machine learning technique to determine, for each transactional document, a discount amount prediction, a discount deadline prediction, a processing deadline, and/or the like. As such, transaction management platform 230 may process the discount amount prediction, the discount deadline prediction, the processing deadline, and/or the like, to generate a recommended processing time period by which the client organization should schedule processing of a transactional document in order to maintain eligibility for a particular discount. In some cases, a discount may depend on a particular volume of sales. Here, transaction management platform 230 may track sales volume for a particular product, and generate a recommended processing time period by which the client organization will have sold enough product to be eligible for the discount. In some cases, transaction management platform 230 may automatically implement the scheduling information.

In this way, transaction management platform 230 is able to perform one or more actions associated with correction or prevention of transaction processing errors.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

By performing actions to prevent transaction processing errors, transaction management platform 230 conserves processing resources that might otherwise be used to resolve issues relating to duplicate transactions and/or problematic transactions. Additionally, by performing actions that are preventative or proactive in nature, transaction management platform conserves processing resources and/or network resources relative to an inferior platform that is only able to resolve issues reactively (e.g., the inferior platform may spend processing resources and/or network resources to execute error correction procedures). Furthermore, by correcting and/or preventing transaction processing errors, transaction management platform 230 conserves financial resources of the client organization (e.g., by reducing or eliminating transaction processing errors, by reducing or eliminating human resources devoted to managing the processing of transactions, etc.).

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, communicatively coupled to the one or more memories, to:
obtain historical transactional information associated with a set of historical transactional documents between a client organization and a vendor organization;
determine one or more trends associated with values included in the set of historical transactional documents by using one or more machine learning techniques to process the historical transactional information;
receive a set of transactional documents associated with transactions between the client organization and the vendor organization;
generate, based on the one or more trends, a first set of exceptions indicating that one or more transactional documents, of the set of transactional documents, are problematic transactional documents;
generate, using a similarity analysis technique, a second set of exceptions indicating that one or more additional transactional documents, of the set of transactional documents, are duplicate transactional documents,
wherein the duplicate transactional documents have caused an account of the client organization to update erroneously or are capable of causing the account of the client organization to update erroneously;
generate a set of claims based on at least one of:
one or more exceptions, of the first set of exceptions, or
one or more exceptions, of the second set of exceptions,
wherein each claim verifies:
an exception, of the first set of exceptions, as a valid exception, or
an exception, of the second set of exceptions, as a valid exception; and
perform, based on the set of claims, one or more actions associated with correction or prevention of transaction processing errors relating to the set of transactional documents.

2. The device of claim 1, wherein the first set of exceptions includes at least one of:
a first exception to flag a transactional document as having a threshold chance of causing the account of the client organization to update erroneously,
a second exception to flag the transactional document as having a threshold chance of including incorrect values,
a third exception to flag the transactional document as having a threshold chance of causing or influencing a cancellation,
a fourth exception to flag the transactional document as having a threshold chance of causing or influencing a processing dispute, or
a fifth exception to flag the transactional document as having a threshold chance of causing or influencing a delivery issue.

3. The device of claim 1, wherein the one or more processors, when generating the first set of exceptions, are to:
generate an exception, of the first set of exceptions, to flag a transactional document, of the one or more transactional documents, as being a problematic transactional document; and
wherein the one or more processors, when performing the one or more actions are to:
compare one or more values identified in the flagged transactional document to one or more corresponding values included in the set of historical transactional documents,
wherein the one or more corresponding values are associated with a trend, of the one or more trends, and are to be used as replacement values,
generate an updated transactional document that includes the one or more corresponding values, and
provide the updated transactional document to a particular device associated with the client organization to allow the particular device associated with the client organization to replace the flagged transactional document with the updated transactional document.

4. The device of claim 1, wherein the one or more processors, when generating the second set of exceptions, are to:
execute a direct matching technique to compare one or more values included in a first additional transactional document, of the set of transactional documents, and one or more corresponding values included in a second additional transactional document, of the set of transactional documents,
determine that the values included in the first additional transactional document match the corresponding values that are included in the second additional transactional document, and
generate an exception, of the second set of exceptions, based on determining that the values included in the first additional transactional document match the corresponding values that are included in the second additional transactional document.

5. The device of claim 1, wherein the one or more processors, when generating the set of claims, are to:
generate a claim, of the set of claims, indicating that a particular exception, of the second set of exceptions, is a valid exception,
the particular exception indicating that a particular additional transactional document is a duplicate transactional document that has caused the account of the client organization to update erroneously; and
wherein the one or more processors, when performing the one or more actions, are to:
generate a request to credit the account of the client organization based on the claim indicating that the particular exception is valid, and
provide the request to a particular device associated with the vendor organization.

6. The device of claim 1, wherein the one or more processors, when generating the set of claims, are to:
generate a claim, of the set of claims, indicating that a particular exception, of the second set of exceptions, is a valid exception,
the particular exception indicating that a particular additional transactional document is a duplicate transactional document that is capable of causing the account of the client organization to update erroneously; and
wherein the one or more processors, when performing the one or more actions, are to:
generate a request to prevent the particular additional transactional document from being processed, and
provide the request to a particular device associated with the client organization.

7. The device of claim 1, wherein the one or more processors are further to:
determine, after determining the one or more trends, a first time period at which a particular device associated with the vendor organization is likely to provide a duplicate transactional document of a particular additional transactional document to the one or more processors;
generate, for the particular additional transactional document, scheduling information identifying a second time period at which to process the particular additional transactional document,
wherein the second time period is before the first time period and the client organization is eligible to receive a discount if the particular additional transactional document is processed before the second time period; and
provide the scheduling information to a particular device associated with the client organization to permit the particular device associated with the client organization to process the particular additional transactional document before the second time period.

8. A method, comprising:
obtaining, by a device, historical transactional information associated with a set of historical transactional documents between a client organization and a vendor organization;
training, by the device, one or more data models on the historical transactional information,
wherein the one or more data models are able to identify one or more trends associated with values included in the set of historical transactional documents;
receiving, by the device, a set of transactional documents associated with transactions between the client organization and the vendor organization;
providing, by the device, one or more values included in a particular transactional document, of the set of transactional documents, as input to a data model, of the one or more data models,
wherein the one or more values included in the particular transactional document, when input to the data model, cause the data model to output one or more prediction values,
wherein each prediction value indicates a likelihood of a particular value, of the one or more values included in the particular transactional document, being an indicator that the particular transactional document is a problematic transactional document;
generating, based on the one or more prediction values, a first set of exceptions indicating that one or more transactional documents, of the set of transactional documents, are problematic transactional documents;
generating, by the device and by using a similarity analysis technique, a second set of exceptions indicating that one or more additional transactional documents, of the set of transactional documents, are duplicate transactional documents,
wherein the duplicate transactional documents have caused an account of the client organization to update erroneously or are capable of causing the account of the client organization to update erroneously;
generating, by the device, a set of claims based on at least one of:
one or more exceptions, of the first set of exceptions, or
one or more exceptions, of the second set of exceptions,
wherein each claim verifies:
an exception, of the first set of exceptions, as a valid exception, or
an exception, of the second set of exceptions, as a valid exception; and
performing, by the device and based on the set of claims, one or more actions associated with correction or prevention of transaction processing errors relating to the set of transactional documents.

9. The method of claim 8, wherein generating the second set of exceptions comprises:
executing a fuzzy matching technique to compare one or more values included in a first additional transactional document, of the set of transactional documents, and one or more values included in a second additional transactional document, of the set of transactional documents,
wherein the fuzzy matching technique is used to determine that a threshold number of values included in the first additional transactional document match corresponding values that are included in a second additional transactional document, and
generating an exception, of the second set of exceptions, based on determining that the threshold number of values included in the first additional transactional document match corresponding values that are included in the second additional transactional document.

10. The method of claim 8, wherein training the one or more data models comprises:
training a data model, of the one or more data models, by using a machine learning technique to process the historical transactional information,
wherein the machine learning technique is:
a clustering technique,
a regression technique, or
an estimation technique.

11. The method of claim 8, wherein performing the one or more actions includes at least one of:
a first one or more actions that cause a particular device associated with the client organization to prevent a duplicate transactional document from being processed,
a second one or more actions that cause a particular device associated with the vendor organization to request a credit to the account of the client organization,
a third one or more actions that cause a particular device associated with a sales representative of the client organization to reduce a chance of a transactional document being cancelled,
a fourth one or more actions that cause a particular device associated with a delivery manager of the client organization to reduce a chance of a transactional document incurring a delivery issue, or
a fifth one or more actions that cause a particular device associated with an employee of the client organization to reduce a chance of a transactional document being associated with a processing dispute.

12. The method of claim 8, wherein generating the first set of exceptions comprises:
generating an exception, of the first set of exceptions, to flag a transactional document, of the one or more transactional documents, as having a threshold chance of being associated with at least one of:
a cancellation,
a processing dispute, or
a delivery issue; and
wherein performing the one or more actions comprises:
generating a recommendation that includes resolution information,
wherein the recommendation is:
a first recommendation that includes resolution information to reduce a likelihood of the transactional document causing or influencing the cancellation,
a second recommendation that includes resolution information to reduce a likelihood of the transactional document causing or influencing the processing dispute, or
a third recommendation that includes resolution information to reduce a likelihood of the transactional document causing or influencing a delivery issue, and
providing, to a particular device associated with the client organization,
the first recommendation,
the second recommendation, or
the third recommendation.

13. The method of claim 8, wherein generating the first set of exceptions comprises:
generating an exception, of the first set of exceptions, to flag a transactional document, of the one or more transactional documents, as having a threshold chance of being associated with at least one of:
a cancellation,
a processing dispute, or
a delivery issue; and
wherein performing the one or more actions comprises:
comparing one or more discrepancies identified in the flagged transactional document to a master transactional document,
the master transactional document including verified values that are to be included in the flagged transactional document,
generating an updated transactional document based on verified values included in the master transactional document, and
providing the updated transactional document to a particular device associated with the client organization to allow the particular device associated with the client organization to replace the flagged transactional document with the updated transactional document.

14. The method of claim 8, further comprising:
generating, after training the one or more data models, scheduling information identifying a first time period at which to process a particular transactional document of the set of transactional documents,
wherein the first time period is before a discount deadline set by the vendor organization; and
providing the scheduling information to a particular device associated with the client organization to permit the particular device associated with the client organization to process the particular transactional document before the first time period.

15. A non-transitory computer-readable medium storing instructions, the instructions comprising:
one or more instructions that, when executed by one or more processors, cause the one or more processors to:
obtain historical transactional information associated with a set of historical transactional documents between a client organization and a vendor organization;
determine one or more trends associated with values included in the set of historical transactional documents by using one or more machine learning techniques to process the historical transactional information;
receive a set of transactional documents associated with transactions between the client organization and the vendor organization;
generate, based on the one or more trends, a first set of exceptions indicating that one or more transactional documents, of the set of transactional documents, are problematic transactional documents;
generate, using a similarity analysis technique, a second set of exceptions indicating that one or more additional transactional documents, of the set of transactional documents, are duplicate transactional documents,
wherein the duplicate transactional documents have caused an account of the client organization to update erroneously or are capable of causing the account of the client organization to update erroneously;
provide the first set of exceptions and the second set of exceptions to a device associated with the client organization,
wherein the device associated with the client organization generates a set of claims based on at least one of:
one or more exceptions, of the first set of exceptions, or
one or more exceptions, of the second set of exceptions,
wherein each claim verifies:
an exception, of the first set of exceptions, as a valid exception, or
an exception, of the second set of exceptions, as a valid exception;
receive the set of claims from the device associated with the client organization; and
perform, based on the set of claims, one or more actions associated with correction or prevention of transaction processing errors relating to the set of transactional documents.

16. The non-transitory computer-readable medium of claim 15, wherein the one or more trends include at least one of:
a first trend indicating that a particular value included in a historical transactional document, of the set of historical transactional documents, has a threshold chance of causing the account of the client organization to update erroneously,
a second trend indicating that the particular value included in the historical transactional document, of the set of historical transactional documents, has a threshold chance of causing or being associated with a cancellation,
a third trend indicating that the particular value included in the historical transactional document, of the set of historical transactional documents, has a threshold chance of causing or being associated with a processing dispute, or
a fourth trend indicating that the particular value included in the historical transactional document, of the set of historical transactional documents, has a threshold chance of causing or being associated with a delivery issue for a product or service relating to the historical transactional document of the set of historical transactional documents.

17. The non-transitory computer-readable medium of claim 15, wherein the one or more instructions, that cause the one or more processors to receive the set of claims, cause the one or more processors to:
receive a claim, of the set of claims, indicating that a particular exception, of the first set of exceptions, is a valid exception,
the particular exception indicating that a particular transactional document is a duplicate transactional document that has caused or is capable of causing the account of the client organization to update erroneously; and
wherein the one or more processors, when performing the one or more actions, are to:
generate:
a first request to prevent the particular transactional document from being processed, or
a second request to credit the account of the client organization, and
provide the first request to a particular device associated with the client organization or the second request to a particular device associated with the vendor organization.

18. The non-transitory computer-readable medium of claim 15, wherein the one or more instructions, when executed by the one or more processors, further cause the one or more processors to:
generate, after receiving the set of claims, summary statistics associated with the set of claims,
the summary statistics including at least one of:
a total number of transactional documents processed over a time period,
a total number of exceptions identified over the time period,
a total number of claims received over the time period,
a frequency at which a particular type of exception is generated over the time period, or
a number of unidentified exceptions that caused or influenced a transaction processing error, of the transaction processing errors, over the time period; and
provide the summary statistics for display on a user interface of a particular device associated with the client organization and/or a device associated with the vendor organization.

19. The non-transitory computer-readable medium of claim 15, wherein the one or more instructions, that cause the one or more processors to generate the first set of exceptions, cause the one or more processors to:
generate an exception, of the first set of exceptions, to flag a transactional document, of the one or more transactional documents, as being a problematic transactional document; and
wherein the one or more instructions, that cause the one or more processors to perform the one or more actions, cause the one or more processors to:
compare one or more values identified in the flagged transactional document to one or more corresponding values included in the set of historical transactional documents,
wherein the one or more corresponding values are associated with a trend, of the one or more trends, and are to be used as replacement values,
generate an updated transactional document that includes the one or more corresponding values, and
provide the updated transactional document to a particular device associated with the client organization.

20. The non-transitory computer-readable medium of claim 15, wherein the one or more instructions, when executed by the one or more processors, further cause the one or more processors to:
generate, after determining the one or more trends, scheduling information identifying a time period at which to process a particular transactional document of the set of transactional documents,
wherein the time period is before a discount deadline set by the vendor organization; and
automatically schedule the particular transactional document to be processed before the time period.
